(19) United States
(12) Patent Application Publication
(10) Pub. No.: US 2015/0149888 A1
(43) Pub. Date: May 28, 2015

(54) SYSTEMS AND METHODS FOR EXECUTING ASPECTS OF A DOCUMENT

(71) Applicant: Moboom Ltd., Subiaco (AU)

(72) Inventors: Jeffrey David Rice, Belvedere Tiburon, CA (US); Benjamin Peter Sargent, Calgary (CA); David John Penner, San Francisco, CA (US)

(21) Appl. No.: 14/543,383

(22) Filed: Nov. 17, 2014

Related U.S. Application Data
(60) Provisional application No. 61/909,953, filed on Nov. 27, 2013.

(51) Int. Cl. G06F 17/30

(52) U.S. Cl. CPC G06F 17/30893
USPC 715/234

(57) ABSTRACT

Methods and systems are disclosed for processing a document request. A document request is received over a network from a client. The document may be composed of a plurality of parts. The parts in the plurality of parts are identified. The plurality of parts may comprise one or more widgets. Parts in the first plurality of parts may be executed via respective different servers to generate respective outputs, which may comprise mark-up language code. The respective outputs may be combined to generate the requested document and the document is provided over the network to the requesting client.

### INCORPORATION BY REFERENCE TO ANY PRIORITY APPLICATIONS

Any and all applications for which a foreign or domestic priority claim is identified in the Application Data Sheet as filed with the present application, are hereby incorporated by reference in their entirety under 37 CFR 1.57.

### BACKGROUND OF THE INVENTION

1. Field of the Invention

The field relates to rendering electronic documents, such as documents defined using a markup language.

2. Description of the Related Art

A conventional method for loading a webpage relies on one server to load all aspects and parts of the webpage, from top to bottom. Conventionally, a web browser may send a request for the contents of a webpage to the server that hosts the page. This server then begins executing the code for the page. Once the server has finished executing the code for the page, it sends the resulting HTML back to the web browser which renders the webpage.

Conventionally, when executing the code, the server executes the code from top to bottom; that is, the server sequentially executes the code that defines the page, so that a first part of the code is executed, and then the next part of the code is executed, and so on until all the code is sequentially executed.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later. It is understood that while various aspects are described, certain embodiments may include any combination of the described aspects, or subsets thereof.

An example method disclosed herein comprises receiving a document request from a client, partitioning the requested document into at least a first plurality of parts, executing each part in the first plurality of parts on a respective different server to generate respective outputs (e.g., comprising HTML code), combining the respective outputs into a document, and providing the document to the client. By way of example, the document may optionally comprise a webpage comprised of concatenated HTML code. Optionally, some or all of the parts in the first plurality of parts are executed substantially simultaneously.

The operation of combining the respective outputs into a document may be performed by a renderer system comprising at least hardware. The first plurality of servers may optionally comprise virtual servers or may comprise physically separate server systems. Optionally, the first plurality of parts comprises widgets.

Optionally, the document comprises a text part, an image part (e.g., markup text indicating where a browser should load the image from), and link part. Optionally, the method further comprises executing the image part using an image part server, executing the link part using a link part server, executing the text part using a text part server. Optionally, a first server in the first plurality of servers is configured to execute a different language than a second server in the first plurality of servers. Optionally, combining the respective outputs further comprises concatenating the respective outputs.

### BRIEF DESCRIPTION OF THE DRAWINGS

Embodiments will now be described with reference to the drawings summarized below. These drawings and the associated description are provided to illustrate example embodiments, and not to limit the scope of the invention.

FIG. 1 illustrates a conventional method for rendering a page.

FIG. 2 illustrates a conventional method for executing webpage code on a server.

FIG. 3A illustrates an example process and architecture for generating parts of page on multiple servers and then combining those parts into a webpage.

FIG. 3B illustrates an example process and architecture utilizing incompatible programming languages to generate a webpage.

FIG. 4 illustrates an example process for executing webpage code simultaneously on multiple servers.

FIG. 5 illustrates example page layout and process that can be used to separate parts of a webpage.

### DETAILED DESCRIPTION

Disclosed herein are techniques for using multiple systems to execute different parts of a document, such as a webpage, to thereby expedite the document generation process and/or to reduce loads on a given computer executing document code.

For example, a system may receive a document request (e.g., a webpage request in the form of an HTTP(s) (Hypertext Transfer Protocol) request) over a network from a client device (e.g., a user terminal, such as a browser-equipped mobile computing device, desktop computer, communication device, etc.). The requested document may be comprised of a plurality of parts. Parts included in the plurality of parts may be executed on respective different servers to generate respective outputs (e.g., comprising HTML code). The respective outputs may be combined into a document (e.g., a webpage comprising the combined respective HTML code outputs), and the document may be transmitted over the network to the requesting client device. Optionally, some or all of the parts are executed by respective servers substantially simultaneously. Thus, by having the document parts executed by multiple servers, optionally simultaneously, the document (e.g., the webpage) may be delivered more quickly to the requesting user device, providing a more pleasing browsing experience.

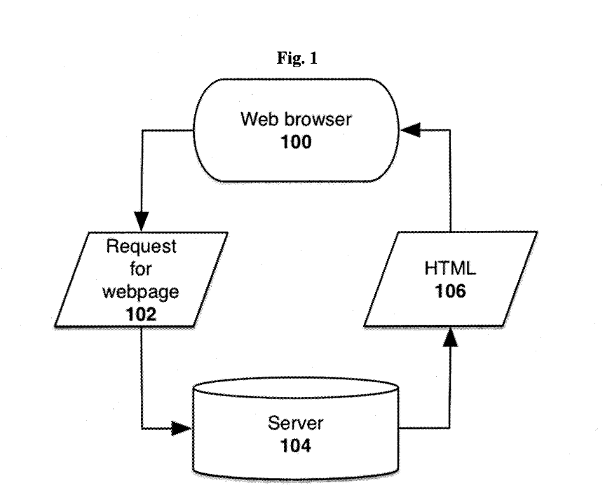

By contrast, a conventional method for generating a webpage relies on a single server to generate all aspects and parts of the webpage, from top to bottom. As illustrated in FIG. 1, with this conventional method of generating a page, a web browser 100 sends a request for the contents of a webpage 102 to the server 104 that hosts the page 102. This single server 104 then begins sequentially executing the code for the page. Once the single server 104 has finished executing the code for the page, it sends the resulting HTML 106 back to the web browser.

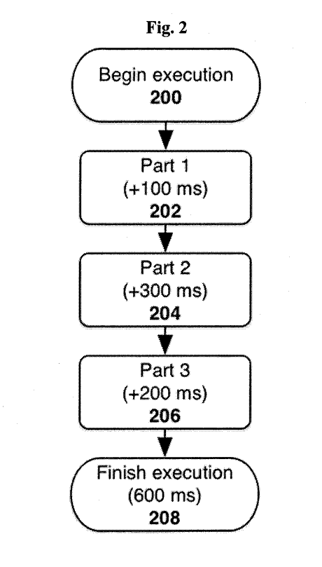

With reference to FIG. 2, conventionally, when executing the code, the server executes the code from top to bottom; that is, the server sequentially executes the code that defines the page, so that a first part of the code is executed, and then the next part of the code is executed, and so on until all the webpage code is sequentially executed. An example illustrating the process of executing the code sequentially is represented in FIG. 2 by 202, 204, and 206.

Because webpages are different from one another, the code of a given webpage can be grouped in variety of ways. For the purposes of explanation, the conventional example illustrated in FIG. 2 splits the code-execution process into three parts. When executing the code 200, the server first executes Part 1 at state 202, which takes 100 milliseconds (ms) in this example. Once Part 1 is executed, the server executes Part 2 at state 204, which takes another 300 ms. Once Part 2 is executed, the server then executes Part 3 at state 206, which takes still another 200 ms. The server then finishes executing the code at state 208.

This conventional method of executing code for a webpage suffers from at least the following disadvantages:

(a) The total time for the execution process is the sum of the execution time required for each part. With respect to the foregoing example illustrated in FIG. 2, the total time is:

100 ms (Part 1)+300 ms (Part 2)+200 ms (Part3)=600 ms

Conventionally, the total execution time will grow whenever a new part is added to the webpage. For example, if another part were added that took 300 ms to execute, then the total time would increase to 900 ms. While a developer might be able to refine the code for a part to reduce the execution time, the total execution time will not be less than the sum of the execution time for each part of the webpage.

(b) Conventionally, the server 104 is setup with a particular framework, and therefore each of the parts of a single webpage must be written in a programming language that is compatible with that framework. So if the code for a webpage is written to run in one particular framework, and a developer wants to add code to the webpage that was written to run in a different incompatible framework, then the developer must recreate either the code or the webpage so that both are written in compatible programming languages.

Some or all of the foregoing disadvantages are addressed using the systems and methods described herein.

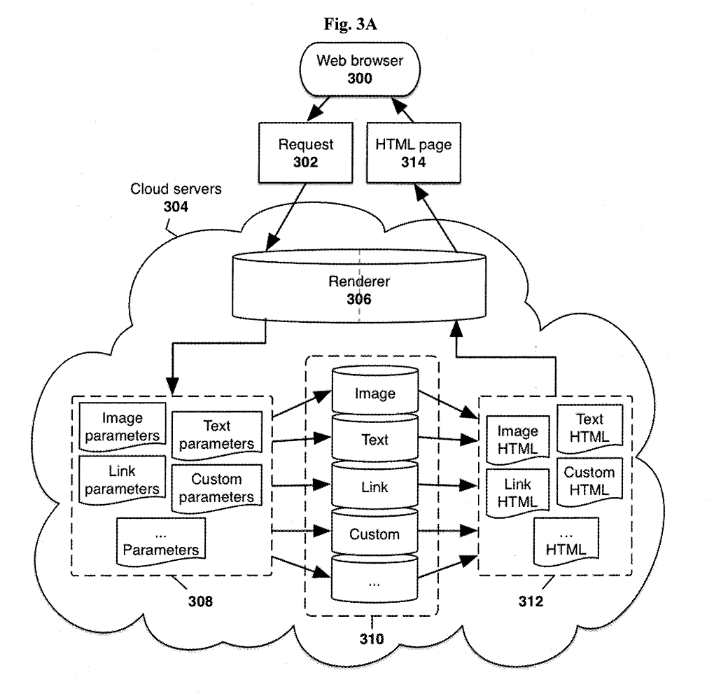

As will discussed in greater detail below and with reference to FIG. 3A, the code for a document, such as a webpage, may be separated into several parts 308, and these parts 308 (which may correspond to respective widgets) may be executed independently on separate servers 310 that produce separate data fragments 312, which in one embodiment can be in the form of HTML fragments. A renderer 306 may combine the data fragments to produce a single or unified document, such as a webpage, which may be displayed via a browser that issued a request for the webpage (although the webpage may include code that will cause additional content, such as an ad or video, to be included in the webpage when the webpage code is executed and rendered by the browser).

Because code parts execute on separate servers, they can optionally execute simultaneously in order to reduce execution time. For example, optionally the code parts execute on separate servers at exactly the same time or in substantially overlapping time periods, where corresponding data fragments are produced by the servers within the same 5 ms, 10 ms, 20 ms, or 50 ms time period. Optionally, different servers 310 can produce the data fragments using respective different programming languages, thereby enabling incompatible programming languages to generate a webpage.

It is understood that while certain example embodiments are described as having each document part executed on a separate server, a given server may execute two or more document parts simultaneously or sequentially. It is also understood that while, in certain embodiments, different servers may produce data fragments using different programming languages, optionally two or more of the servers may use the same programming language.

### First Example Embodiment

FIG. 3A illustrates an example process and architecture for executing parts of a page (e.g., simultaneously) on multiple servers and then combining the resultant code into a webpage.

A web browser 300 hosted on a user terminal (e.g., a mobile communication device (e.g., a mobile phone), a desktop computer, a laptop computer, a tablet computer, a smart television system, etc.) transmits, at block 302, a request over a network (e.g., the Internet) for a webpage. Optionally, the request may be in the form of a URL which is converted to an HTTP request. The request may be received by a remote system, such as a system of cloud servers 304. A renderer 306, which in this example is hosted in the server cloud, receives the request. The renderer 306 is an engine that can accept a request and output the appropriate markup text, such as in HTML in this embodiment.

After receiving the request, the renderer 306 accesses a document database that stores document (e.g., webpage) content. For example, document content may include information about which widgets exist on a document, how the widget instances are arranged, what styling is applied to the widgets, and/or other information. However, the code for the widgets may optionally be stored separately from the document content on respective servers. A given widget may be associated with a unique identifier (a widget ID), and the document content may identify the widgets used in the document via the corresponding widget IDs. Optionally, the document content may be stored in a tree structure using a JSON (JavaScript Object Notation) human-readable document. The JSON protocol utilizes data structures, including ordered lists (recognized as “arrays”) and name/value pairs (recognized as “objects”). However, other protocols may be used, such as XML, YAML, or non-standardized protocols.

Example document content for an illustrative webpage is provided below:

```
{
  “name”: “Sample Page”,
  “slug”: “sample”,
  “id”: “4a161015-e3f5-0773-0bdd-5435742e2547”,
  “type”: 1,
  “seo_pattern”: “”,
  “status”: 1,
  “keywords”: “”,
  “description”: “”,
  “content”: [
```

```
{
  “container”: true,
  “css_class”: “row-fluid”,
  “css_id”: null,
  “css_style”: null,
  “extension_id”: “ad2aaec7-6ba0-4784-93da-16e0bcdf843e”,
  “name”: “Container”,
  “type”: “div”,
  “sort_order”: 0,
  “settings”: [ ],
  “content”: [
```

```
{
  “container”: false,
  “css_class”: “span12”,
  “css_id”: null,
  “css_style”: null,
```

“extension_id”: “127b5481-914c-e630-b65a-

5137ad7dfa5c”,

```
  “initialized”: true,
  “invisible”: false,
  “name”: “Rich Text”,
  “type”: “widget”,
  “sort_order”: 0,
  “settings”: {
```

“text”: “<p>Sample page.</p>”

```
  },
  “version”: “1.0.0”
}
```

]
}

]
}

The underlined portion in this example corresponds to a call to a “Rich Text” widget.

A partitioning module of the renderer 306 breaks the request into several separate parts. For example, each part may correspond to a widget included in the document, where the widget is identified by a widget ID. A widget may be in the form of a relatively small, self-contained software application or component that may provide access to a larger application. For example, a widget may provide access to a library of photographs, to a single image, to real time stock quotes, to news, other live-feeds, to advertisements, etc. The partitioning module sends the parameters 308 (e.g., image parameters, link parameters, text parameters, custom parameters, etc.) for these parts to separate servers 310. The parameters may be stored in the page content, in the document database. The parameters may be in the form of key/value pairs, where the values may be strings or arrays of additional key/value pairs. The parameters instruct the widget on how to customize the output (e.g., the HTML output) for the final webpage presentation

Optionally, each separate part (e.g., widget) executes on a separate server that may be dedicated to storing code for and executing only that part or that may be dedicated to storing code for and executing only parts of that type. For example, the image part (e.g., markup text indicating where a browser should load the image from) may be executed by an image part server (which may store the image part widget code), the link part (e.g., markup text indicating a URL or other link) may be executed by a link part server (which may store the link part widget code), and the text part may be executed by a text part server (which may store the text part widget code), etc.

Optionally, these separate servers are virtual servers. Optionally, a given server may execute more than one part of a webpage. For example, each server may be configured to execute two parts of a webpage, or a server may be configured to execute all parts of a given type (e.g., all image parts may be executed by the same image part server, all link parts may be executed by the same link part server, etc.). One or more virtual severs may reside and run on the same computer system to provide services over a network to clients, such as the browser 300.

By way of example, the partitioning module may optionally access a part (e.g., widget) routing table which indicates which part/widget is to be executed by which server (e.g., by identifying the server IP address (e.g., the server address and port address)). For example, the part routing table may include a list of parts and identify the respective associated server. By way of illustration, when the partitioning module receives a part (e.g., a widget) execution request from the renderer 306, the request may include the corresponding part identifier (e.g., widget ID) that was included in the document content. The partitioning module utilizes the part identifier (e.g., widget ID) to lookup in the widget routing table which server is configured to execute the corresponding part (e.g., widget), where the server is identified via an IP address. Optionally, for a given widget, there may be more than one route/server available to choose from to facilitate load balancing.

The code of each part, when executed by the respective server, generates a data fragment, which in this embodiment is an HTML fragment 312, and each server sends this fragment back to the renderer 306. For example, AN image part server may generate an image HTML data fragment, a text part server may generate a text HTML data fragment, a link part server may generate a link HTML data fragment, a custom part server may generate a custom HTML data fragment, etc. The renderer 306, using a concatenation module, concatenates or aggregates these fragments and outputs an answer to the original request, which in this embodiment means that the renderer 306 sends an HTML webpage 314 over the network back to the web browser 300 that originated the request.

### Example Operation

### First Example Embodiment

The process illustrated in FIG. 3A will now be described in greater detail. The web browser 300 transmits a request for a webpage 302, which is received by the renderer 306. The renderer 306 breaks up the work needed to complete the request into multiple parts 308, and the renderer 306 sends the parameters for these parts 308 to separate virtual servers 310. What constitutes a part might be different for each webpage, however, the process identifies parts that are independent enough to generate a data fragment without directly interacting with the other parts—even if that data fragment is dependent on the data fragments generated by the other parts.

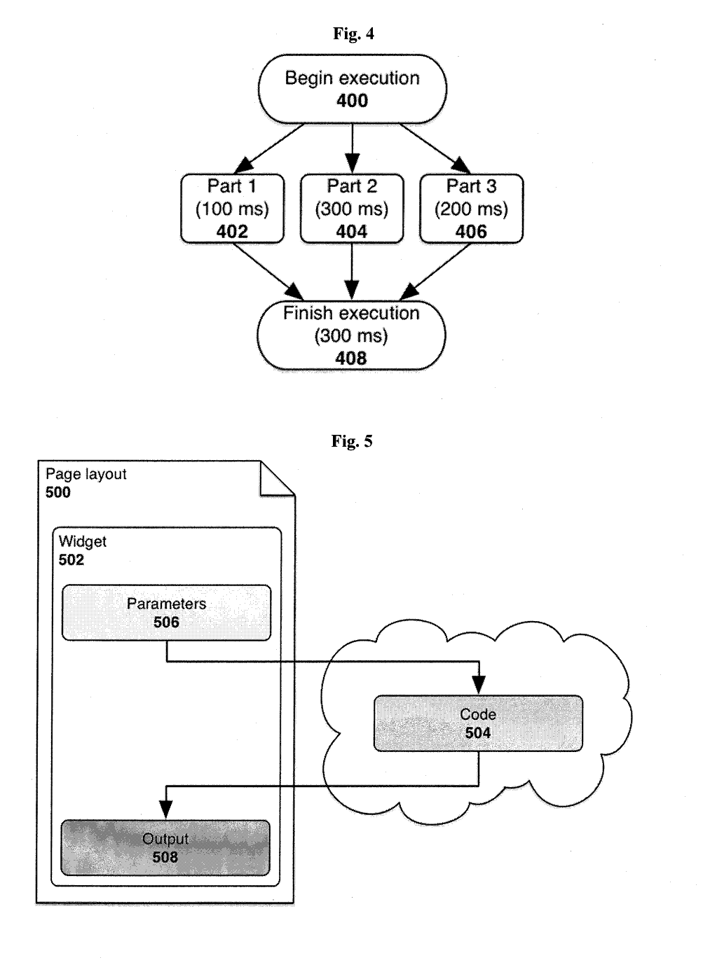

In this example embodiment, a method of determining the individual parts uses a widget model, but other techniques may also be used. An example of the widget model is illustrated in FIG. 5, which depicts an example page layout and process that can be used to separate parts of a webpage.

A page layout 500 can be used to determine the organization and appearance of an outputted page, such as the outputted page 314 illustrated in FIG. 3A. A given page layout comprises one or more requests for a widget 502 (e.g., via a widget call, such as “name”: “Rich Text”, “type”: “widget”, for a call to a Rich Text widget). A widget contains code 504 that is configured to input parameters 506 and then execute the code independently of other widgets to produce an output 508. In the example widget model, some or all aspects of a page are produced by predefined widgets. For example, one widget might be responsible for displaying an image, another widget might responsible for displaying text, and another widget might be responsible for displaying links.

The page layout, which in this embodiment exists in the renderer, stores information about which widgets exist on a page, how the widget instances are arranged, what styling is applied to the widgets, and/or other information necessary for properly displaying the output of the widgets. However, the code for the widgets may be stored independently of the page layout.

As illustrated in FIG. 5, in this example the code 504 for a widget is not stored in the page layout; instead the code for a given widget is stored on a respective individual virtual server 310. Optionally, if there are different widgets on a page, the code for each widget may be stored on a respective different server. After receiving a web browser request (e.g., the request 302 illustrated in FIG. 3), the renderer (e.g., renderer 306) examines the page layout and determines which widgets to request. The renderer then transmits the parameters (e.g., parameters 308) for these widgets to the appropriate server (e.g., the virtual servers 310). For example, if the page layout contains an image widget, then the renderer would send the parameters for the image widget to the image-widget server, which stores the code for the image widget.

Creating the virtual servers can take several seconds, so creating the servers at run time might slow down the entire process. Optionally, one or multiple virtual servers may be created for each type of widget supported by the system prior to receiving the original request (e.g., request 302) is an example solution, but other methods are also suitable. By way of example, optionally, servers for the more common widget types are created prior to receiving the original request, and servers for the remaining widgets are created at run time (after receiving the request). Creating the servers in advance also helps the renderer understand where to send the parameters for a given widget. For example, in one embodiment, the server may access a list that maps a given widget to an Internet Protocol (IP) address that is the location for the corresponding server.

The instantiation of virtual servers may be managed via a control server, which may determine if a requested server has not been instantiated (or if it has crashed and is not operable), and if the requested server has not been instantiated (or if it has crashed), the control server may dynamically instantiate the server. Optionally, the control server may instantiate multiple servers executing the same widget code for load balancing purposes. For example, if three requests are made to execute the same widget type, the control server may determine if there are any corresponding instantiated servers available to serve the request, and if so, route the request to the available instantiated server. If the control server determines that all of the instantiated servers are currently executing code, the control server may optionally create additional instantiations of the server. Thus, the control server may perform load balancing with respect to widget execution requests.

This technique has several ramifications, but one ramification is that each server is executing code independently, and so optionally the servers can execute code simultaneously or substantially simultaneously, instead of consecutively.

When the code for each part (e.g., each widget) is executed simultaneously, the total execution time for all parts is about equal to the part with the longest execution time. One ramification of this embodiment is that a document developer can continue to add additional parts (e.g. widgets) to a document, and the total execution time will remain substantially constant as long as the execution time for those parts is less than the execution time for the part with longest execution time. As described above with respect to certain conventional approaches and as illustrated in FIG. 2, the prior method for adding additional parts required executing the code for a webpage consecutively. Thus, using conventional techniques, when additional parts were added to a document (e.g., a webpage) the execution time would always increase.

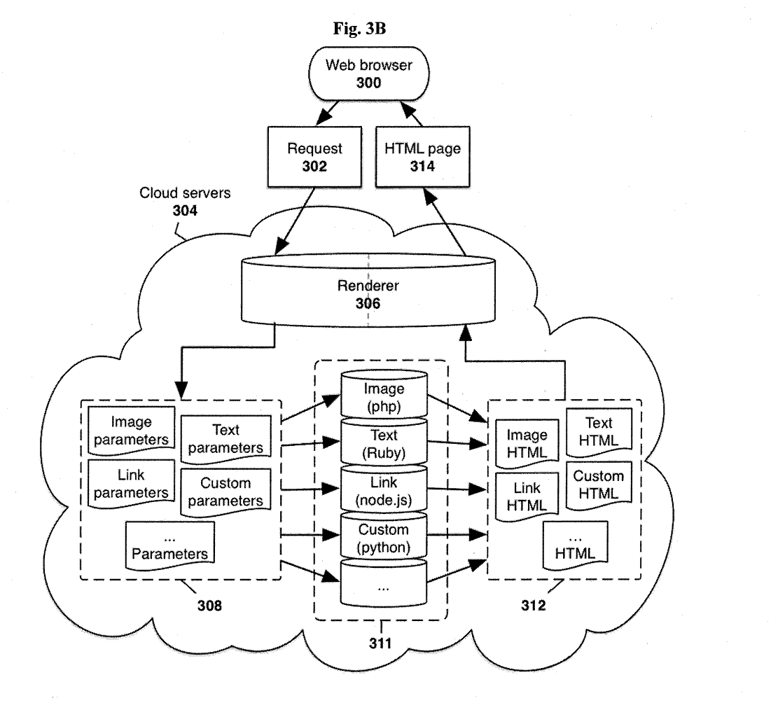

FIG. 4 illustrates an example process for executing webpage code simultaneously on multiple servers to thereby expedite webpage code execution. It may take a short amount of time (e.g., less than 50 ms, although it may take a longer or shorter amount of time) for the renderer to break up the page into respective messages to pass to the widget renderers. The widget renderers can then begin their execution (e.g., less than 50 ms after the render starts processing the page). In this example, once the execution of code parts begins at block 400, separate servers 402, 404, 406, begin substantially simultaneously respectively executing Part 1 (by server 402), Part 2 (by server 404), and Part 3 (by server 406). After 100 ms, server 402 has finished executing Part 1. After 200 ms, server 406 has finished executing Part 3. After 300 ms, server 404 has finished executing Part 2. Thus, in this example the total execution time for all parts is equal to the execution time for Part 2 (300 ms), which is the part with the longest execution time.

In this embodiment, the servers are virtual servers, and may optionally be dynamically created as necessary. For example, if a renderer (e.g., renderer 306) breaks the request into three parts (where the requested document includes three widgets), then three virtual servers may be created, one for each part/widget. However, if, for example, the renderer breaks the request into 99 parts, then 99 virtual servers can be created, one for each part. In the 99 parts scenario, if each of the 99 parts takes 100 ms to execute, then the total execution time is about 100 ms as the servers begin executing the parts substantially simultaneously. By contrast, using the conventional method illustrated in FIG. 2, the execution time for that scenario would be 9.9 seconds (9,900 ms).

### Additional Example Embodiments

### Code Written in Incompatible Programming Languages

As described above with respect to conventional approaches, webpage widget code executed by a single server needs to use compatible programming languages. However, because the output of server-side programming languages is intended to be interpreted by a web browser, the output is typically in HTML.

Optionally, the servers 310 illustrated in FIG. 3A can be configured to use any programming languages which may be implemented on various frameworks. FIG. 3B illustrates an example process and architecture utilizing incompatible programming languages to generate a webpage (e.g., the HTML code for the webpage). Optionally, each server 311 (which corresponds to servers 310 in FIG. 3A) independently executes the parameters 308 sent by the renderer 306, and so the programming languages (e.g., scripting languages) that generate the data fragments 312 can be incompatible with each other. For example, the image part server may be configured to use the PHP programming language, the text part server may be configured to use the Ruby language (e.g., implemented using the Ruby framework or other framework), the link part server may be configured to use the Node.js (a platform built on Chrome's JavaScript runtime) language, the custom part server may be configured to use the Python language, etc. Each server may be configured to provide a corresponding HTML fragment, which may then be concatenated/aggregated by the render 306 into a webpage (the HTML code for the webpage), and which returns the webpage HTML code to the requesting browser 300. The browser may execute the HTML code and display the resulting webpage. Therefore, in this embodiment, code for one webpage can successfully be written in multiple incompatible languages.

Optionally, there may be servers supporting different programming languages for a given part type. For example, there may be a first image part server configured to use the PHP programming language and a second image part server configured to use the Ruby programming language.

With the widget model described earlier (and illustrated in FIG. 5), optionally each widget could be written in a programming language that is incompatible with the programming language of other widgets. Since each virtual server optionally executes just the code for one widget, the virtual server 311 would simply use the appropriate framework. Thus, a programmer programming a widget could use the most suitable or preferred programming language, and different widget programmers may elect to use different programming languages. Further, webpage designers can select which widgets to include in the page without having to be concerned about the programming language the widgets are programmed in.

Thus, unlike conventional technologies that permit only a few specific incompatible languages to work together, this embodiment is not limited to specific languages. This optional feature enables developers to write webpage code in any language as long as the responses from the virtual servers 312 can be reassembled into a compatible format such as HTML.

Variations on the Output

While the examples embodiment illustrated in FIGS. 3A and 3B generate data fragments as HTML fragments 312, the fragments indicated in 312 may be in any form; HTML is simply one example embodiment of the data fragments.

In this example, a web browser 300 requests a webpage 302. The response initiates a process that transforms code into an HTML webpage 314. Additional embodiments can use a variety of data formats for the data fragments 312 and for the eventual output 314. Thus, the request for a webpage 302 may instead be a request for any type of document or data in other data formats. Examples of additional data formats include, but are not limited to: Extensible Markup Language (XML), character-separated values (CSV), and JavaScript Object Notation (JSON).

Virtual or Physical Servers

As noted above, optionally, the servers 310 that produce the data fragments 312 are virtual servers. Virtual servers can be created as needed. For example, if the renderer 306 determines that the optimal way to process the request 302 is with 99 parts, then the render can cause 99 corresponding servers to be created.

However, while virtual servers may be a convenient way to handle the execution of multiple parts, the servers 310 or 311 can instead be actual or physical servers. That is, the multiple servers 310 or 311 may be represented by software (virtual servers) executing on a single computer system, by hardware (physical servers), or by any combination of software and hardware (some virtual servers and some physical servers).

Request Origin

In the embodiments illustrated in FIGS. 3A and 3B, the request originates from a web browser 300. However, optionally the request may be instead originated from a server or a different type of software or system capable of requesting information.

Control Server

With the example widget model described earlier (and illustrated in FIG. 5), each type of widget is executed on a separate virtual server. For example, an image widget would run on an image-widget server, a text widget would run a text-widget server, and a link widget would run on a link-widget server.

However, optionally, if a server receives multiple requests, the server may execute two instances of the code substantially simultaneously on two separate threads.

Multiple threads executing substantially simultaneously on the same server share resources. Additionally, several virtual servers are capable of running on one physical server. One embodiment uses a separate control server to examine the amount of resources used, such as memory, and to increase or decrease the amount of servers as needed. Additional virtual servers could be created on physical servers that have more available resources.

By way of example, if the control server determines that an image-widget server needs additional resources, then the control server can identify a physical server with available resources and then create another image-widget server to handle some of the work

Asynchronous Loading

By executing code parts for a webpage separately, an example embodiment is able to provide for display a webpage relatively faster by removing parts that take longer to execute (e.g., that take or are estimated to take more than a specified threshold of time). For example, the renderer 306 can concatenate and output only the HTML fragments 312 that have been generated by a certain specified time threshold.

Using the example illustrated in FIG. 4, if the threshold is set to 200 ms, then the renderer would concatenate Part 1 402 and Part 3 406 and transmit concatenated Parts 1 and 3 back to the browser as the final HTML webpage 314. Therefore, the code would take 200 ms to execute instead of 300 ms; although, Part 2 404 would be excluded from the final output.

Optionally, the time threshold may be varied by the renderer 306 based on one or more criteria. For example, the threshold may be webpage specific (e.g., after a set time period for each webpage, the renderer outputs whatever HTML has been generated so far). By way of further example, using the widget model described earlier (and illustrated in FIG. 5), the threshold may be widget-type specific; for example, all image widgets could be limited to an execution time of 100 ms. Thus, different part or widget types may be assigned different thresholds. Optionally, parts that are considered less important may be assigned a shorter threshold than parts that are considered more important. The determination as to the relative importance of a part may be pre-determined or may be dynamically determined. The widget routing table may specify a priority value which the renderer would then use to determine a maximum execution time. This value may optionally be constant across all instantiations of that particular widget. For example, a widget which renders user content may be given unlimited time to complete, while a widget which renders advertisements may be assigned a lower priority, and therefore less execution time, since its result is not fundamental to the final page.

Optionally, at about the time the time threshold is reached, the renderer 306 may concatenate the HTML fragments 312 and then insert a marker (e.g., any HTML that can be recognized later) into the HTML page 314 for each part that is still executing. The renderer may then send that webpage back to the requesting browser 300. Later, once the part has finished executing, the renderer can load the missing HTML (which is Part 2 404 in the previous example) using Asynchronous JavaScript or other asynchronous script. Thus, the page may be incrementally updated on the requesting browser as the renderer 306 executes more time intensive parts.

Accordingly, the various embodiments of simultaneously executing code can be used to render websites much faster than is possible with the conventional method discussed above. The various embodiments of simultaneously executing code enable developers to solve the long-felt need of combining code written in incompatible languages. The benefits of these embodiments optionally include one or more of the following:
If a webpage is broken into several blocks of code, then its execution time is about equal to the execution time of its most time-consuming block. With the conventional method of executing webpage code (where blocks are executed sequentially), the execution time would be about equal to the sum of the execution time of every block.
Additional code can be added to a webpage without increasing (or substantially increasing) the total execution time as long as the additional code has an execution time that is less than or equal to the most time-consuming block and additional respective servers are provided to handle the additional code so the additional code does not have to be sequentially executed after other webpage code.
Developers are able to create a webpage using code from any programming language that can run on a server and generate output, as long as the responses from the servers can be reassembled into a compatible format (e.g., such as HTML for a webpage).

The methods and processes described herein may have fewer or additional steps or states and the steps or states may be performed in a different order. Not all steps or states need to be reached. The methods and processes described herein may be embodied in, and fully or partially automated via, software code modules executed by one or more general or special purpose computers comprising one or more hardware computing devices. The code modules may be stored in any type of non-transitory computer-readable medium or other computer storage device. Some or all of the methods may alternatively be embodied in whole or in part in specialized computer or state machine hardware. The results of the disclosed methods may be stored in any type of computer data repository, such as relational databases and flat file systems that use volatile and/or non-volatile memory (e.g., magnetic disk storage, optical storage, EEPROM and/or solid state RAM). The servers discussed herein may include (or be hosted on systems that include) network interfaces configured to receive document requests (e.g., webpage requests from a browser) and to transmit responses to the requester. The servers and other devices described herein may optionally include displays and user input devices (e.g., keyboards, touch screens, mice, voice recognition, gesture recognition, etc.).

Many variations and modifications may be made to the above-described embodiments, the elements of which are to be understood as being among other acceptable examples. All such modifications and variations are intended to be included herein within the scope of this disclosure. The foregoing description details certain embodiments. It will be appreciated, however, that no matter how detailed the foregoing appears in text, the invention can be practiced in many ways. The use of particular terminology when describing certain features or aspects of certain embodiments should not be taken to imply that the terminology is being re-defined herein to be restricted to including any specific characteristics of the features or aspects of the invention with which that terminology is associated.

While specific technologies exist to allow one webpage to be written in specific incompatible programming languages, these technologies are limited to specific languages; that is, these technologies do not work with every language. The existence of these technologies is evidence of the long-felt need by developers for the ability to write webpages in incompatible languages. Because these technologies work with only specific languages, they fail to solve this need.

In contrast to conventional techniques described above, in accordance with one embodiment, separate parts of the code for a webpage (or other document) can be executed independently on separate servers in order to produce separate fragments, such as HTML fragments, which can then be combined in a separate rendering engine (e.g., hosted on a separate server) in order to produce a single webpage. Optionally, the rendering engine may be hosted on one of the servers that is also generating fragments.

Accordingly several optional advantages of one or more aspects reduce the total execution time of webpage code and/or enables the data fragments of otherwise incompatible code to be combined into one webpage.

All of the methods and processes described above may be embodied in, and fully automated via, software code modules executed by one or more general purpose computers. The code modules may be stored in any type of computer-readable medium or other computer storage device. Some or all of the methods may alternatively be embodied in specialized computer hardware. The results of the disclosed methods may be stored in any type of computer data repository, such as relational databases and flat file systems that use magnetic disk storage and/or solid state RAM.

While the phrase “click” may be used with respect to a user selecting a control or the like, other user inputs may be used, such as voice commands, text entry, gestures, etc.

Many variations and modifications may be made to the above-described embodiments, the elements of which are to be understood as being among other acceptable examples. All such modifications and variations are intended to be included herein within the scope of this disclosure. The foregoing description details certain embodiments of the invention. It will be appreciated, however, that no matter how detailed the foregoing appears in text, the invention can be practiced in many ways. As is also stated above, the use of particular terminology when describing certain features or aspects of the invention should not be taken to imply that the terminology is being re-defined herein to be restricted to including any specific characteristics of the features or aspects of the invention with which that terminology is associated.

What is claimed is:

1. A computer implemented method comprising:
receiving over a network at a first computer system comprising hardware a request for a webpage from a client device;
accessing by the first computer system webpage content identifying at least a first plurality of widgets included in the requested webpage, the first plurality of widgets comprising a text widget, an image widget, and a link widget;
executing each widget in the first plurality of widgets on a respective different server in a first plurality of servers to generate respective outputs, the respective outputs comprising HTML code, wherein:
the image widget is executed by an image widget server,
the link widget is executed by a link widget server, and
the text widget is executed by a text widget server,
wherein each of the respective different servers begins execution at substantially the same time;
combining, by the first computer system, the respective outputs to generate the requested webpage, the generated requested webpage comprising HTML code; and
providing the requested webpage to the client device.

2. The method as defined in claim 1, wherein combining the respective outputs into a webpage is performed by a renderer system comprising at least hardware.

3. The method as defined in claim 1, wherein a portion of the first plurality of servers are instantiated at least partly in response to receiving the webpage request and a portion of the first plurality of servers are instantiated prior to receiving the webpage request.

4. The method as defined in claim 1, the method further comprising dynamically instantiating the first plurality of servers at least partly in response to receiving the webpage request.

5. The method as defined in claim 1, wherein a first server in the first plurality of servers is configured to execute a different widget language than a second server in the first plurality of servers.

6. The method as defined in claim 1, wherein a first server in the first plurality of servers is configured to execute a different scripting language than a second server in the first plurality of servers.

7. The method as defined in claim 1, wherein a first server in the first plurality of servers is configured to execute Ruby on Rails and a second server in the first plurality of servers is configured to execute PHP.

8. The method as defined in claim 1, wherein combining the respective outputs further comprises concatenating the respective outputs.

9. The method as defined in claim 1, the method further comprising determining if a first of the first plurality of widgets will take more than a first threshold of time to execute, and at least partly in response to determining that the first widget will take more than the first threshold of time to execute, inhibiting a contribution by the first widget from being in included in the generated requested webpage.

10. A computer implemented method comprising:
receiving over a network at a first computer system a request for a webpage from a client device;
accessing, by the computer system, webpage content identifying at least a first plurality of parts included in the requested webpage, wherein each part in the first plurality of parts is associated with a respective unique identifier;
determining which part, in the first plurality of parts, is to be executed by which server based at least in part on the respective part identifier;
based at least in part on the determination of which part is to be executed by which server, executing each part in the first plurality of parts on a respective different server in a first plurality of servers to generate respective outputs, the respective outputs comprising markup language code;
combining, by the first computer system, the respective outputs to generate the requested webpage; and
providing the requested webpage to the client device.

11. The method as defined in claim 10, wherein the parts in the first plurality of parts begin execution at substantially the same time.

12. The method as defined in claim 10, wherein the first plurality of parts comprise an image widget configured to access and display images and a widget configured to access and display a live data feed.

13. The method as defined in claim 10, wherein combining the respective outputs into a document is performed by a renderer system comprising at least hardware.

14. The method as defined in claim 10, wherein the document is a webpage.

15. The method as defined in claim 10, wherein the document comprises a text part, an image part, and link part, the method further comprising executing the image part using an image part server, executing the link part using a link part server, executing the text part using a text part server.

16. The method as defined in claim 10, wherein a first server in the first plurality of servers is configured to execute a different language than a second server in the first plurality of servers.

17. The method as defined in claim 10, the method further comprising determining if a first of the first plurality of parts will take more than a first threshold of time to execute, and at least partly in response to determining that the first part will take more than the first threshold of time to execute, inhibiting a contribution by the first part from being in included in the generated requested document.

18. A system comprising:
a data store comprising a tangible memory device, the data store storing an identification of parts included in one or more documents;
a render, comprising hardware, configured to:
receive a document request from a client;
access the data store and determine what parts are included in the requested document;
a control system configured to:
manage a first plurality of servers;
determine which part, in the first plurality of parts, is to be executed by which server of the first plurality of severs based at least in part on respective part identifiers;
based at least in part on the determination of which part is to be executed by which server, causing each part in the first plurality of parts to be executed on a respective different server to generate respective outputs, the respective outputs comprising markup language code;
wherein the render is further configured to combine the respective outputs to generate the requested document and provide the requested document to the client device.

19. The system as defined in claim 18, wherein the parts in the first plurality of parts begin execution at substantially the same time.

20. The system as defined in claim 18, wherein the first plurality of parts comprise an image widget configured to access and display images and a widget configured to access and display a live data feed.

21. The system as defined in claim 18, wherein the document is a webpage.

22. The system as defined in claim 18, wherein the document comprises a text part, an image part, and link part, the method further comprising executing the image part using an image part server, executing the link part using a link part server, executing the text part using a text part server.

23. The system as defined in claim 18, wherein a first server in the first plurality of servers is configured to execute a different language than a second server in the first plurality of servers.

24. The system as defined in claim 18, the method further comprising determining if a first of the first plurality of parts will take more than a first threshold of time to execute, and at least partly in response to determining that the first part will take more than the first threshold of time to execute, inhibiting a contribution by the first part from being in included in the generated requested document.
